(19) United States
(12) Patent Application Publication
(10) Pub. No.: US 2002/0176223 A1
(43) Pub. Date: Nov. 28, 2002

(54) Modular handheld computer assembly

(76) Inventor: Steven Shiozaki, Belmont, CA (US)

Correspondence Address: HICKMAN PALERMO TRUONG & BECKER, LLP, 1600 WILLOW STREET, SAN JOSE, CA, 95125, US

(21) Appl. No.: 09/864,499

(22) Filed: May 23, 2001

(51) Int. Cl. G06F 1/16

(52) U.S. Cl. 361/636; 361/683

(57) ABSTRACT

A handheld computer assembly is provided that includes a first module combined with one or more modules. The first module includes a housing having one or more coupling surfaces, with each coupling surface including a coupling mechanism. A second module is coupleable to the first module. The second module includes a third coupling surface having a second coupling mechanism for mating with the first coupling mechanism. The third coupling surface is positioned on the second module so as to abut at least partially against the second coupling surface when the first coupling mechanism is mated with the second coupling mechanism.

### FIELD OF THE INVENTION

The present invention relates to handheld computers. In particular, the present invention relates to a handheld computer assembly formed by a combination of modular components.

### BACKGROUND OF THE INVENTION

Handheld computers, typically referred to as personal digital assistants (PDAs), have small sizes to facilitate mobility. The functions that are usually performed by handheld computers may be limited to accommodate the small size. For example, complicated applications may be excluded or reduced on a handheld computer to preserve battery power and processing resources.

To conserve size while providing functionality, some handheld computers perform core functions, and require users to add on modules for additional functionality. Examples of core functions include software for maintaining electronic calendars, address lists, to-do lists, memos and/or email applications.

Handheld computers include one or more expansion ports to enable users to add on other modules to increase functionality. For example, many handheld computers have slots to receive miniature cards. The miniature cards may provide additional memory, or include peripheral devices such as modems.

Still further, other devices include larger add-on modules that combine with the handheld computer in a configuration that preserves the overall size of the device. For example, a PALM V organizer, manufactured by PALM INC., includes a serial port on a bottom surface and an aperture in a back face to electronically combine with an accessory device in a piggy-back fashion. A HANDSPRING VISOR, manufactured by HANDSPRING INC, includes a spring-board slot embedded in a back face of the housing to electronically couple to cards or devices that extend from the device's back face. The springboard module of the VISOR may be used to add modules such as modems, memory packages, and cellular communication capabilities.

### SUMMARY OF THE INVENTION

In an embodiment, a handheld computing assembly is formed by combining separate modules into a single working device. The modules may be selected and combined by users, to enable users to customize a handheld computer assembly for a specific configuration.

In an embodiment, the module of the handheld computer are combined to extend along an axis of the overall device. The modules may be combined to extend lengthwise, so that the combination of modules have the look and feel of a single device. In this way, each module adds to a front panel of the overall handheld computer assembly.

Examples of functionality that can be provided for a handheld computer assembly through the combination of modules include gaming controls, input devices, extended battery capacity, global positioning systems, and extended memory. These modules may be used in a combination that includes a primary module for performing core functions of a handheld computer or other digitizer. The core functions may include maintaining calendars, address books, to-do lists and e-mails.

### BRIEF DESCRIPTION OF THE DRAWINGS

Embodiments of the invention are illustrated by way of example, and not by way of limitation, in the figures of the accompanying drawings. Like reference numerals are intended to refer to similar elements among different figures.

FIG. 1 is a top view of a handheld computer assembly formed from combining two or more modules, under an embodiment of the invention.

FIG. 2 is a side view of a handheld computer assembly shown in FIG. 1, under an embodiment of the invention.

FIG. 3 is an isometric view of two modules being combined to form a handheld computer assembly, under an embodiment of the invention.

FIG. 4 is an isometric view of three modules being combined to form a handheld computer assembly, under an embodiment of the invention.

FIG. 5 is a block diagram of hardware components for a handheld computer assembly, under an embodiment of the invention.

FIG. 6 is an isometric front view of a handheld computer assembly formed by combining a primary module with a first expansion module, under an embodiment of the invention.

FIG. 7 is an isometric front view of a handheld computer assembly formed by combining a primary module with a first expansion module and a second expansion module, under an embodiment of the invention.

FIG. 8 is an isometric back view of a handheld computer assembly shown by FIG. 7, under an embodiment of the invention.

FIG. 9 is an isometric front view of a handheld computer assembly formed by combining a primary module with another first expansion module, under an embodiment of the invention.

FIG. 10 is an isometric front view of a handheld computer assembly formed by a primary module combined with multiple expansion modules that cooperate with one another, under an embodiment of the invention.

FIG. 11 is a front view of a primary module combined with a pair of gaming modules, under an embodiment of the invention.

### DETAILED DESCRIPTION OF THE INVENTION

Embodiments of the invention describe a modular handheld computer assembly. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

A. Overview

In an embodiment, a handheld computer is assembled from multiple modules. Each module includes resources including hardware and/or software for performing functions of a handheld computer assembly. A first module includes a housing for internal components and circuitry. The first housing has a front panel extending lengthwise between a first surface and a second surface. A first coupling mechanism extends from at least one of the first or second surfaces. A second module is coupleable to the first module. The second module has a second housing to store internal components and circuitry. The second housing has a front panel that extends between a third surface and a fourth surface. A second coupling mechanism extends from the third surface to mate with the first coupling mechanism. When the first and second modules are combined, the first or second surface providing the first coupling mechanism abuts against at least a portion of the third surface providing the second coupling mechanism.

Among advantages provided by an embodiment of the invention, a user may configure a handheld computer by selecting modules to be combined into an assembly for specific finctionalities and configurations. The modules may be selected to enable the handheld computer assembly to perform specific functions desired by the user. The modules may also be selected to preserve a general form factor of the handheld computer assembly, with the modules combining along a single axis or length. In one embodiment, two or more modules combine to provide a front panel and a back panel that is relatively uniform across two or more modules.

In an embodiment, a primary module performing core functions can be selectively combined with expansion modules to perform added functions. Examples of peripheral functionalities that can be provided by embodiments of the invention include gaming controls, input devices, extended battery capacity, global positioning systems, and extended memory.

In another embodiment, a handheld computer assembly includes a first module, second module, and third module. The first module includes a first coupling on a first coupling surface, and a second coupling on a second coupling surface. The first module includes a front panel and a back panel that extend a length of the first module. The first coupling surface and the second coupling surface each extend between the front panel and the back panel. The second module including a third coupling that is coupleable to one of the first coupling or the second coupling. The third module includes a fourth coupling, that is coupleable to another of the first coupling or the second coupling.

In an embodiment, each module in the handheld computer assembly is selectable by during an assembly process. The assembly process may be performed by an end user, or during manufacturing. As such, the user can select modules that are to be combined with other modules to form the handheld computer assembly. The modules may be selected on the basis of function. For example, modules may be selected because of specific hardware resources needed to perform certain functions, like digital photography or voice recording. The modules may also be selected on the basis of other factors, such as size, shape or design. In this way, the resulting handheld computer assembly includes selected modules to customize the assembly for peripheral functions, while preventing unnecessary components from affecting an overall size of the device.

In another embodiment, each module includes a coupling surface having a coupling mechanism extending from it. The modules can be combined so that the entire periphery of the coupling surface for one module is in contact with the periphery of the coupling surface of the other module. In this way, the modules connect peripherally, with an entire dimension of each module adding to an overall length of the assembly.

B. Housing Configurations For Modules

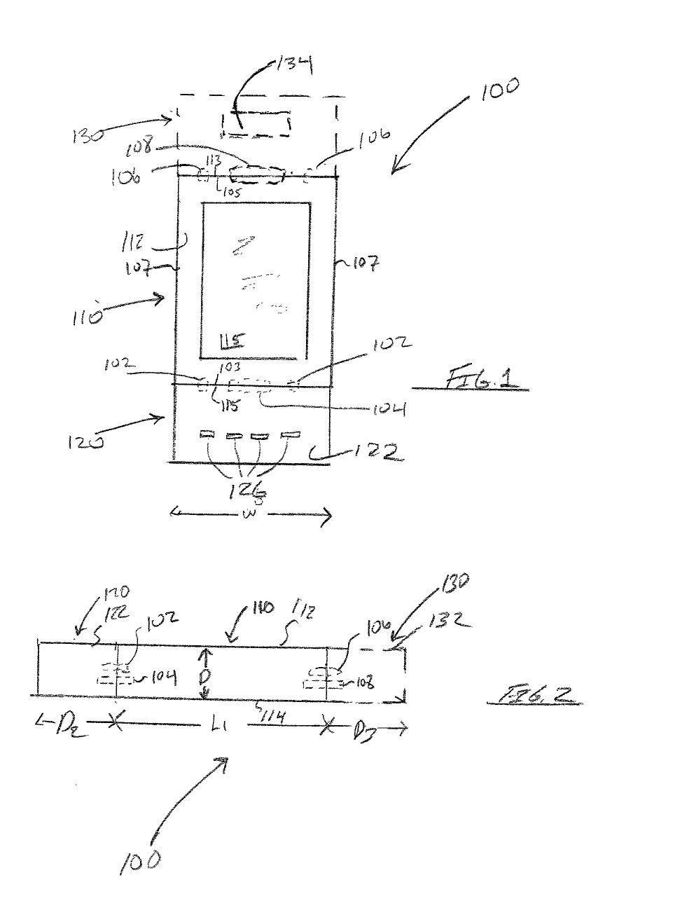

FIG. 1 illustrates a handheld computer assembly 100, under an embodiment of the invention. The handheld computer assembly 100 includes a first module 110 detachably coupled to a second module 120. As an option, first module 110 is detachably coupled to third module 130. As used herein, detachably coupled means that the modules may be combined and separated through manipulation of coupling mechanisms integrated into the housing, without use of tools or other external components.

The first module 110 includes a bottom edge 103, a top edge 105, and a pair of lateral sides 107. The first module 110 includes a display 115 provided on a front panel 112. The display 115 may be contact-sensitive. When coupled, a top edge 115 of second module 120 abuts bottom edge 103 of first module 110. At least a portion of a front panel 122 on second module 120 is parallel to front panel 112 of first module 110. In one embodiment, front panel 122 of second module 120 is coplanar with front panel 112 of first module 110. For an example shown, second module 120 provides a plurality of input mechanisms 126 on front panel 122.

The third module 130 may couple to first module 110 so that a bottom edge 113 of the third module abuts against a top edge 105 of first module 110. For an example shown, third module 130 includes at least a first electrical component 134. The first electrical component 134 may be a processor, memory, battery, or other electrical component. As with second module 120, a front panel 132 of third module 130 is parallel to front panel 112 of first module 110. In one embodiment, at least a portion of each of the front panels 112, 122 and 132 are coplanar.

The first module 110 detachably couples to second module 120 through a coupling mechanism comprising a pair of mechanical couplings 102. The coupling mechanism also includes an electrical coupling 104 extending between first module 110 and second module 120. The electrical coupling 104 is for exchanging an electric signal, such as for signaling communications or for transferring power. In an embodiment, the mechanical couplings 102 are laterally spaced apart from the electrical connector 104. Likewise, first module 110 couples to third module 130 through a detachable coupling mechanism comprising a pair of mechanical couplings 106. The coupling mechanism also includes electrical connector 108.

A maximum width of first module 110 is defined by a maximum distance between lateral sides 107, 107. In an embodiment, second module 120 and third module 130 have at least 75% of the maximum width of first module 110. In one embodiment, second module 120 and third module 130 have approximately the same (within 95%) maximum width as first module 110.

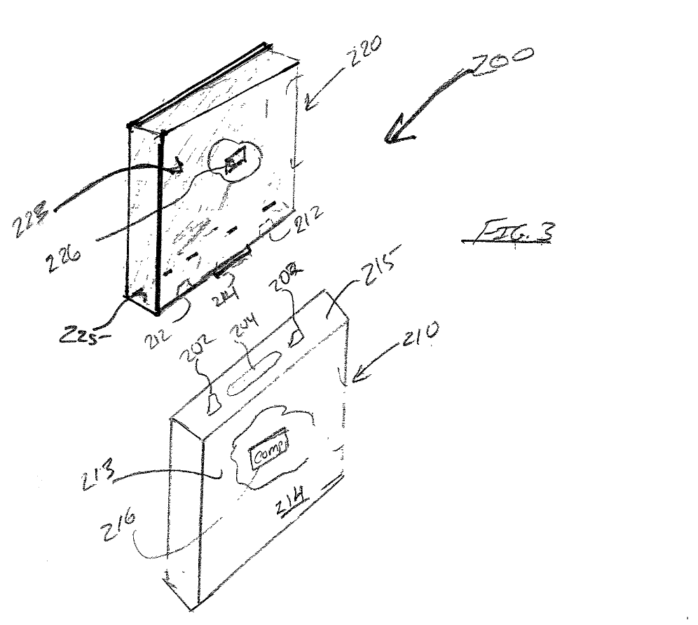

FIG. 2 is a side view of handheld computer assembly 100. The first module 110 is shown to have a depth D, defined as the maximum distance between front panel 112 and a back panel 114. In an embodiment, second module 120 and third module 130 have a maximum depth that is at least 75% of the depth D. In one embodiment, the second module 120 and third module 130 have approximately the same (within 95%) depth as the depth D for first module 110.

The second module 120 detachably couples to first module 110 through mechanical couplings 102 and electrical connector 104. In an embodiment, the mechanical couplings 102 are spaced apart or otherwise staggered from the electrical coupling 104 in the direction of the depth. Likewise, mechanical couplings 106 and electrical connector 108 extending between first module 1 10 and third module 130 may also be spaced apart along the direction of the depth.

In an embodiment, an overall length of the handheld computer assembly 100 is a sum of dimensions for each module. The first module 110 may have the longest length (LI) as it is the center module. The second module 120 and third module 130 each couple to first module 110 end-to-end. As such, a dimension (D2) of second module 120 is additive to L1. A dimension (D3) of third module 130 is also additive to L1 or L1+D2. The combination of the length of first module 110 and the dimensions of second module 120 and 130 combine to provide an overall length of handheld computer assembly 100.

In an embodiment, the modules of the handheld computer assembly share an overall form factor feature. With reference to FIG. 1, first module 110, second module 120, and third module 130 may have approximately the same width W. With reference to FIG. 2, first module 110, second module 120 and third module 130 may have a same depth D. Furthermore, the front panels 112, 122 and 132 of each panel may include portions or be entirely coplanar with one another. The result is that first module 110, second module 120 and third module 130 combine to form an assembly that has the appearance of being unitary.

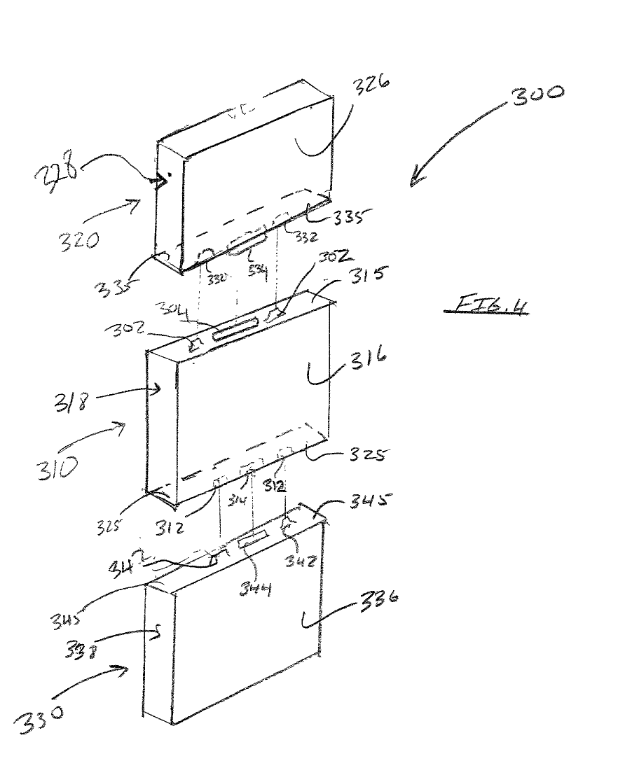

FIG. 3 is an isometric view of a handheld computer assembly 200 including a first module 210 and a second module 220. The first module 210 includes a first coupling surface 215. The first coupling surface 215 includes coupling mechanisms for mating with other modules. A housing 213 includes one or more electrical components 216 and corresponding circuitry or other resources for performing functions for a handheld computer assembly 100. Similarly, second module 220 includes a second coupling surface 225 (shown in phantom) having coupling mechanisms for engaging corresponding mechanisms of first module 210. A housing 223 of second module 220 may be used to retain at least a second component 226 and corresponding circuitry or resources. The second component 226 cooperates with first component 216 in performing functions for handheld computer assembly 200.

The coupling mechanisms of first module 210 include a pair of latches 202 and a connector 204. The coupling mechanisms of second module 220 includes openings 212 (shown in phantom) aligned and configured to receive latches 202. The coupling mechanism of second module 220 may also include a pin connector 214 configured to mate with first connector 204. The latches 202 may be biased to engage apertures 212 of second module 220.

In other embodiments, the mechanical couplings employed may be snap-fit couplings or other detachable fasteners. The electrical connector may be a plug or serial port connector.

In an embodiment, first module 210 and second module 220 are coupled using an active engagement including a mechanical coupling and an electrical coupling. For example, the pair of latches 202, 202 or other mechanical couplings are extended between first module 210 and second module 220 to create an active mechanical engagement. In an active engagement, the mechanical engagement is in addition to any mechanical forces inherent from mating of the connectors 204, 214.

Alternatively, a passive engagement may be used to couple first module 210 with second module 220 and/or third module 230. A passive engagement is formed when the coupling mechanism between first module 210 and second module 220, and/or third module 230 is an inherent mechanical force of electrical connectors coupled to one another. For example, a pin connector may be used to passively engage first module 210 with second module 220, without use of any other mechanical couplings.

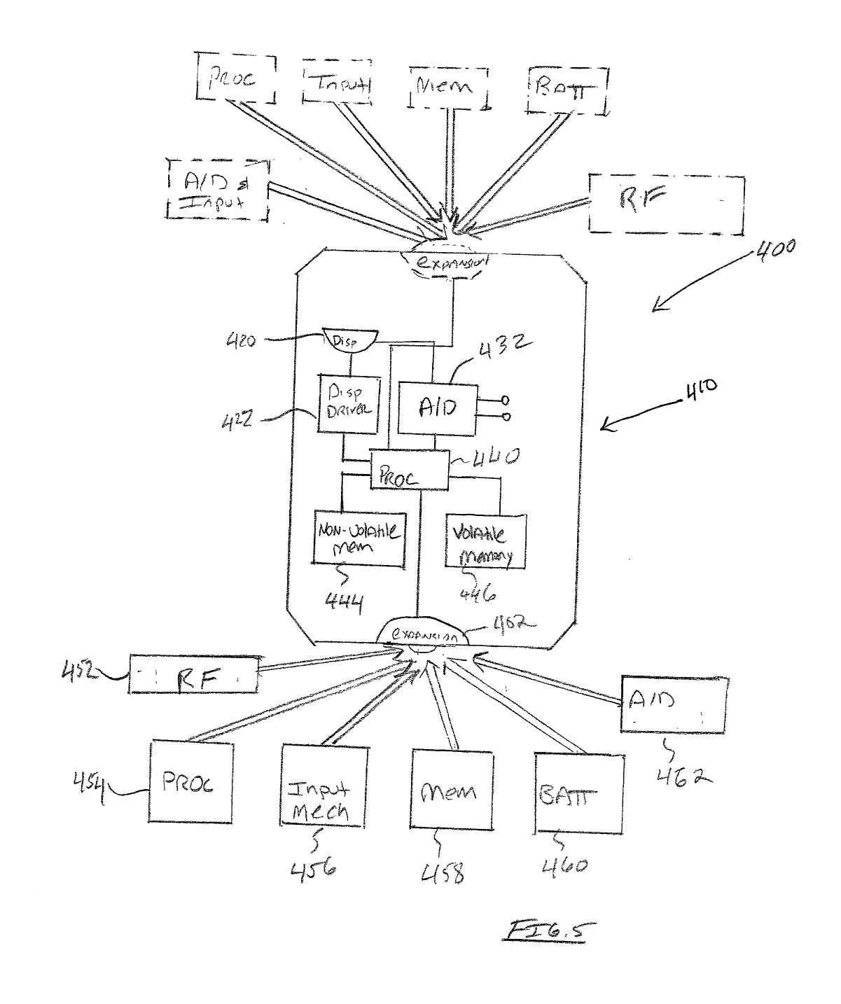

FIG. 4 is an isometric view of a handheld computer assembly 300 comprising a first module 310, a second module 320 and a third module 330. The first module 310 has a housing 318 formed by a front panel 316, a back panel (not shown), a first coupling surface 315 and a second coupling surface 325 (shown in phantom). The first coupling surface 315 and second coupling surface 325 extend between and oppose one another across front panel 316 and the back panel. The first coupling surface 315 includes latch elements 302, 302 and connector 304. The second coupling surface 325 includes latch apertures 312, 312 (shown in phantom) and connector 314.

The second module 320 includes a housing 328 formed partially from a front panel 326, a back panel (not shown), and a third coupling surface 335 (shown in phantom) extending between front panel 326 and the back panel. The third coupling surface 325 includes latch apertures 332, 332 (shown in phantom) and connector 334. The latch apertures 332 are aligned to engage latch elements 302, 302 of first module 310. The connector 334 is configured and positioned to mate with the connector 304 of the first module 310. In an embodiment, one of the connectors 304, 334 is a male pin connector, and the other connector 304, 334 is a female pin connector. The third coupling surface 335 is configured to abut the first coupling surface 315 when first module 310 and second module 320 are combined.

Likewise, third module 330 includes a housing 338 formed partially from a front panel 336, a back panel (not shown), and a fourth coupling surface 345 extending between the front panel 336 and the back panel. The fourth coupling surface 345 includes latch elements 342, 342 and connector 344. The latch elements 344 are positioned to engage latch apertures 312, 312 of first module 310 when the first module and third module 330 are brought together. The connector 344 is positioned to mate with the connector 314 on the second coupling surface 325. The fourth coupling surface 345 is configured to abut the second coupling surface 325 when first module 310 and third module 330 are combined.

C. Hardware Diagram

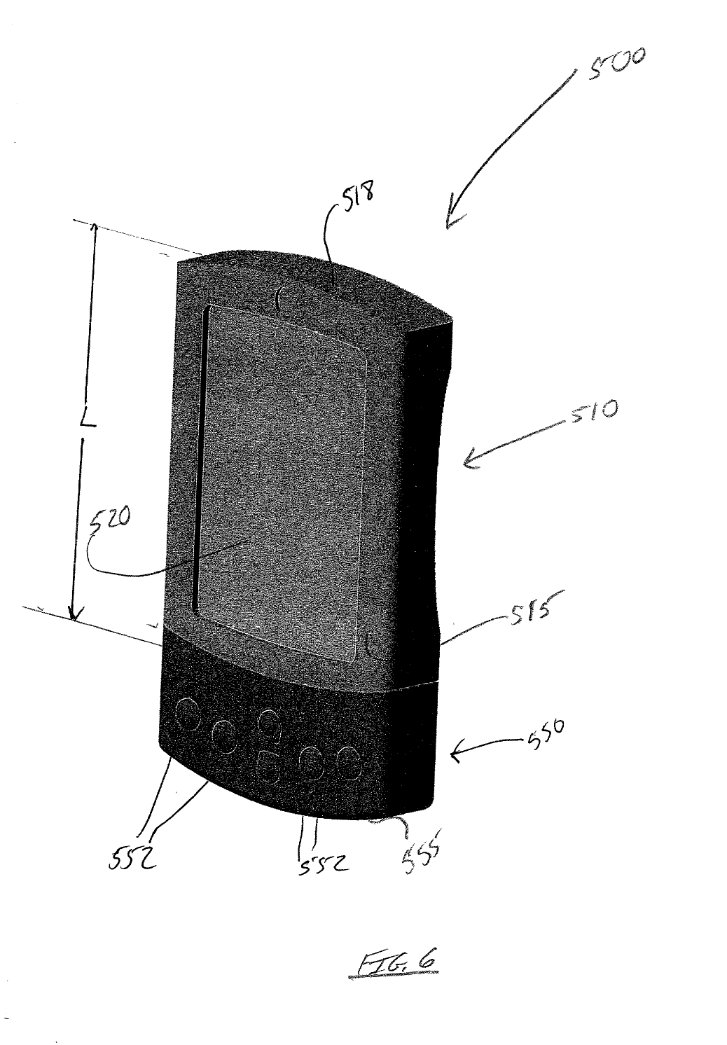

FIG. 5 is a block diagram for a handheld computer assembly 400 formed from multiple modules, under an embodiment of the invention. One of the modules in the handheld computer assembly is a primary module 410 that carries a majority of the components for performing the core functions of the handheld computer assembly 400. The primary module 410 may be coupleable to any one of a plurality of peripheral or expansion modules.

In an embodiment, the primary module 410 includes a processor 440 coupled to a first memory 444 (non-volatile) and a second memory 446 (volatile). The processor 440 is coupled to a display driver 422. The processor 440 combines with display driver 422 to process and signal data for presentation on a display component 420. The display component 420 includes a display surface (not shown) on a portion of the primary module's housing. The display component 420 may also include a digitizer (not shown) to make the display contact-sensitive. An analog-digital (AD) converter 432 is coupled to processor 440. One or more channels from A/D converter 432 maybe used to convert analog input provided by the digitizer, or by another analog input mechanism.

The primary module 410 include one or more expansion ports for coupling to other modules. In an embodiment shown, a first expansion port 402 enables one or more types of expansion modules to be connected to processor 440. The primary module 410 also includes a second expansion port 404 to couple to another expansion module. Each port 402, 404 is shown to be coupled to processor 440, although the components that receive a signal from one of the expansion ports 402, 404 are determined by the type of expansion module selected.

The expansion modules that may be coupled to expansion port 402 are identified in FIG. 5 according to internal components. Each expansion module may include one or more of the following set of components: a radio-frequency transmitter and/or receiver 452, a processor 454, an input mechanism 456, additional memory 458, a battery 460, or another A/D converter 462. The same components may be used with expansion modules to second expansion port 404.

D. Exemplarv Handheld Computer Assemblies

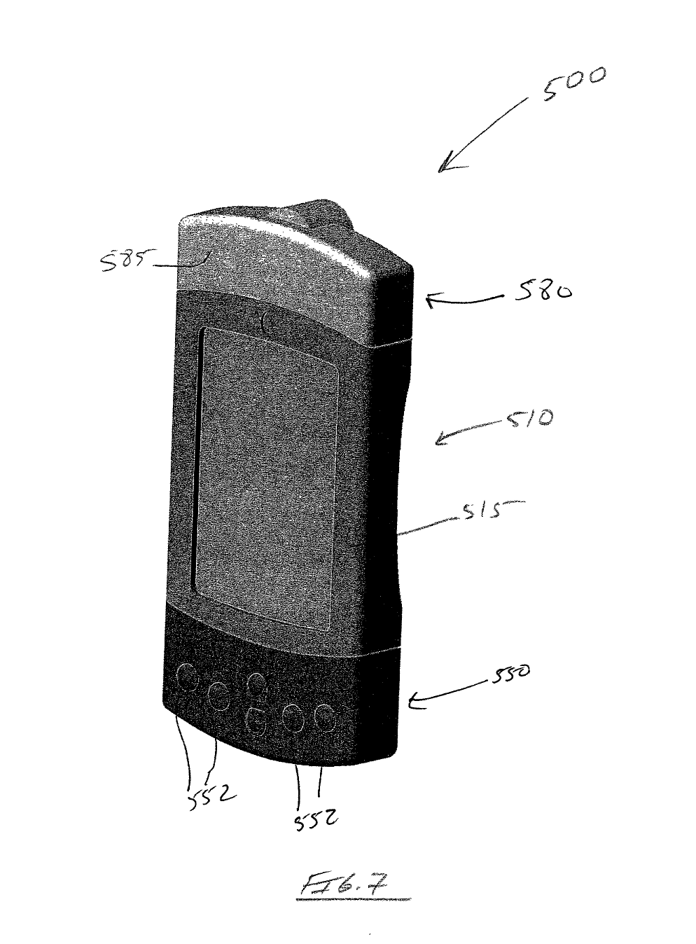

FIG. 6 illustrates a handheld computer assembly 500 including a primary module 510 and an expansion module 550. The primary module 510 includes components such as a display 520, provided on a portion of a front panel 515. The expansion module 550 connects into a bottom surface (not visible) of primary module 510. The expansion module 550 provides a plurality of input mechanisms 552 (buttons) on a front panel 555. The primary module 510 is oriented lengthwise (distance L), so that expansion module 550 connects to primary module 510 in a manner that adds to the overall length of the whole assembly. In an embodiment, front panel 555 is substantially coplanar with front panel 515 of primary module 510. Other embodiments may provide portions of front panel 555 to be contoured, with regions proximate to primary module 510 being coplanar or of the same contour as front panel 515 of primarymodule 510. As such, input mechanisms 552 are adjacent or proximate to display 520.

As with other modules, an embodiment provides that primary module 510 is selectable, either by the user or during a manufacturing process. The primary module 510 may be selected for certain characteristics, such as for example, a size of display 520, or the overall dimensions of the primary module's housing. In particular, a user may choose between a primary module 510 having a large display 520, as opposed to one with a smaller display.

In an embodiment, primary module 510 is equipped to couple to two expansion modules at the same time. The primary module 510 may include coupling mechanisms to add expansion modules along a vertical axis. A top panel 518 of primary module 510 may be removable to house a coupling mechanism (not shown) on an interior surface. For example, top panel 518 may be slideably removed in a lateral direction from primary module 510. A pin connector (not shown), latch or other coupling mechanism may reside within top panel 518 to couple to another module at the option of the user.

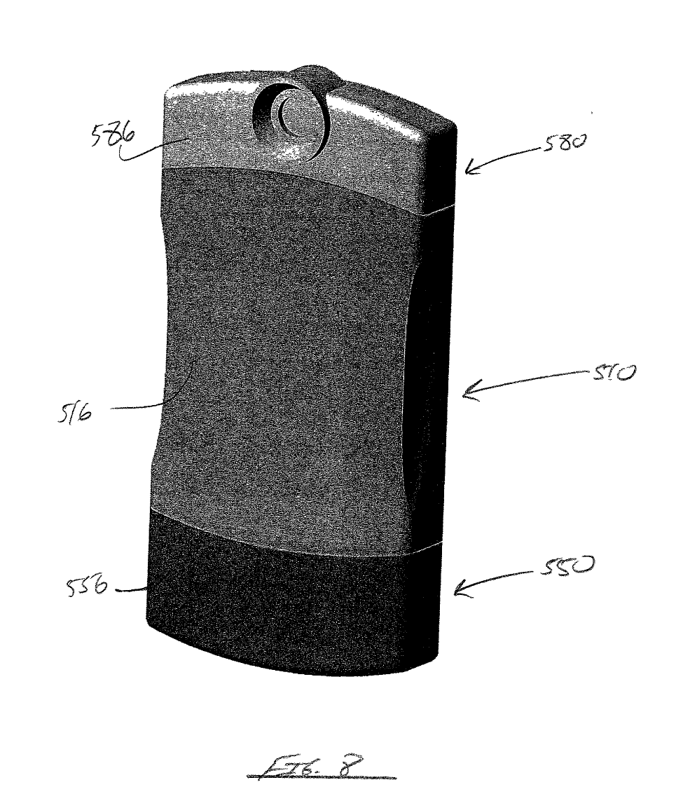

FIG. 7 illustrates a second expansion module 580 connected to the top surface 518 of primary module 510. The second expansion module 580 includes front panel 585 that is substantially coplanar with front panel 515 of primary module 510. Other embodiments may provide portions of front panel 585 to be contoured, with regions proximate to primary module 510 being coplanar or of the same contour as front panel 515 of primary module 510.

In an embodiment, first expansion module 550 includes internal components for detecting and forwarding input from buttons 552. The buttons 552 may be pre-assigned to cause a processor of primary module 510 to perform specific functions. For example the set of buttons 552 on front panel 555 may include navigation buttons for scrolling an image on display 520, or application buttons for entering selections.

In an embodiment shown, second expansion module 58 includes a digital camera. The digital camera may include internal components such as a processor, a memory and/or a battery unit. In addition, the digital camera may include a lens and a light detector. The digital camera may communicate with the processor of primary module 510 to provide captured images for display 520. In addition, the captured images of second expansion module 580 may be stored in one of the memory components internal to primary module 510. The buttons 552 of first expansion module 550 may be used to operate second expansion module 580. Therefore, second expansion module 580 may be controllable by either primary module 510 or first expansion module 550.

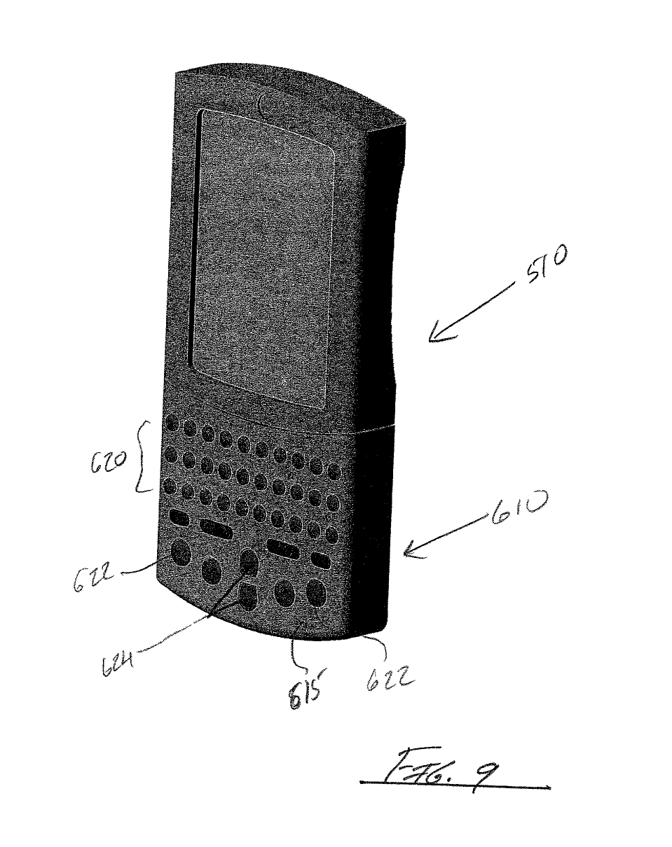

FIG. 8 illustrates a back view of primary module 510 coupled to first expansion module 550 and second expansion module 580. A back panel 516 of primary module 510 is parallel to the front panel 515. The first expansion module 550 includes a back panel 556. The second expansion module 580 includes a back panel 586. In an embodiment, back panels 516, 556 and 586 are coplanar. Other embodiments provide portions of back panel 516 proximate to primary module 510 being coplanar with back panel 516. Similarly, portions of back panel 586 may be coplanar with the back panel 516 of primary module 510.

In an embodiment, one or more of the expansion modules may use a back panel to incorporate internal/external components in a manner that reduces dimensions. For example, pack panel 586 includes lens 592 for use in capturing images.

While FIGS. 6-8 illustrate first expansion module 550 and second expansion module 580 being inter-coupled through primary module 510, an embodiment provides that each module of handheld computer assembly can be coupled to other modules. For example, first expansion module 550 may be directly coupled to second expansion module 580. As an example, positions of first expansion module 550 and second expansion module 580 may be reversed relative to primary module 510.

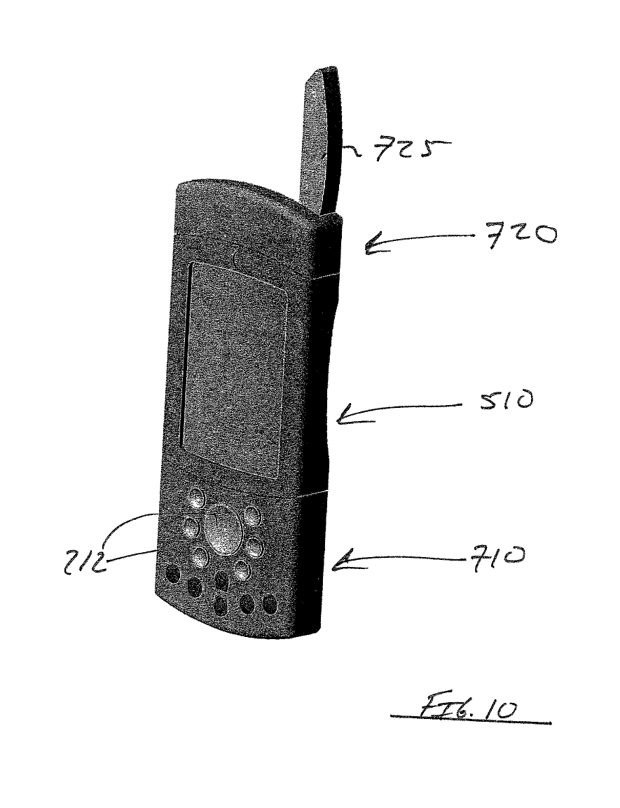

FIG. 9 illustrates another embodiment where primary module 511 is coupled to a second expansion module 610. A front panel 615 of second expansion module 610 provides a QWERTY keyboard 620, as well as a plurality of application buttons 622 and navigation buttons 624. To accommodate additional input mechanisms, second expansion module 610 may have an extended length, while other dimensions such as its width and depth are made the same or compatible with dimensions of primary module 510.

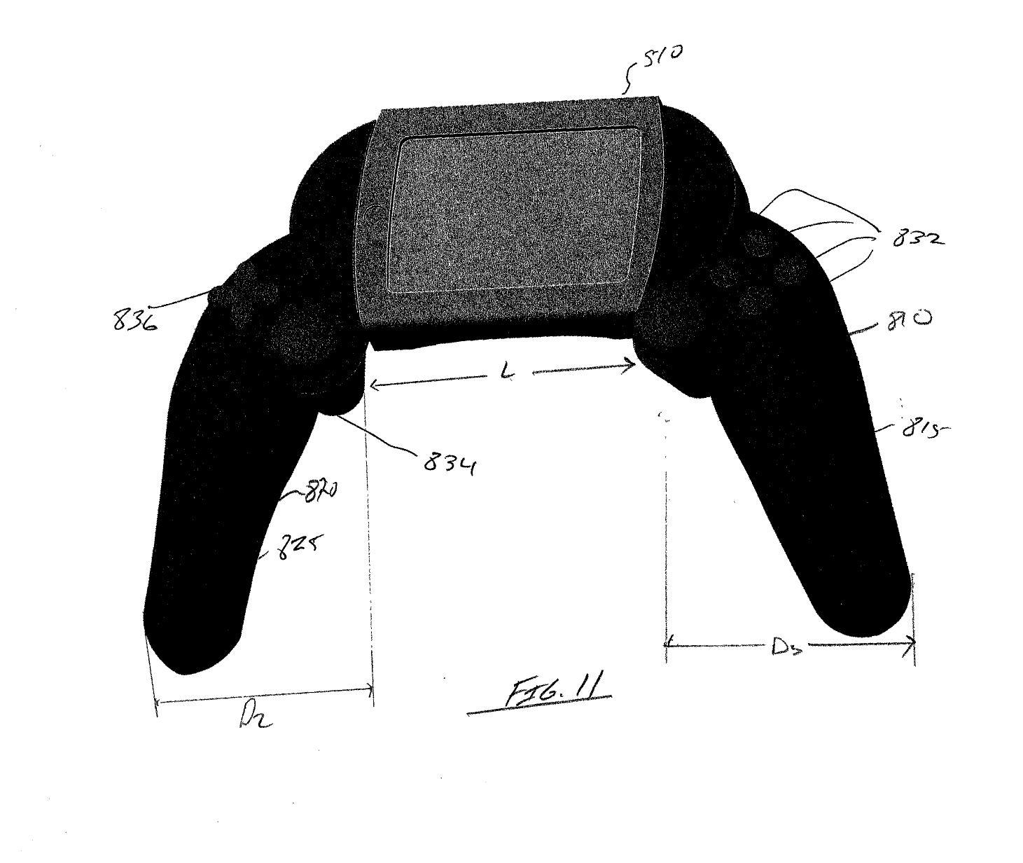

FIG. 10 illustrates an embodiment where primary module 510 is coupled to a second expansion module 710 that is used in cooperation with a third expansion module 720 for a specific type of functionality. Therefore, an embodiment of the invention allows for first expansion module 710 and second expansion module 720 to be added to primary module 510 so as to convert the handheld computer assembly 500 into a specific type of handheld computer assembly.

In an example provided, second expansion module 710 is an input module configured for a global positioning system (GPS). The input mechanisms 712 provided on a front panel 710 may be for scrolling an image in multiple directions, and for selecting input for use with a GPS unit. The second expansion module 720 includes radio frequency transmitter and receiver (now shown) for processing GPS communication received from a base station, as well as for signaling requests based on input received on first expansion module 710. The transmitter and receiver may include an antenna element 725, as well as a second processor for converting to and from radio frequency communications.

FIG. 11 illustrates an embodiment where primary module 510 is extended lengthwise along distance L, with a pair of input modules connected to each end of primary module 510. The input modules include a left game module 810 and a right game module 820, where each game module includes input mechanisms and internal components to receive and process rapid input. In an example provided, one or both game modules 810, 820 includes buttons 832, analog joystick 834 and 8-directional pads 836. One or more internal A/D converters may convert analog input received from the joystick 834 or directional pad 836.

Each game module 810, 820 includes a corresponding housing 815, 825. The housings 815, 825 are shaped for gripping by a user. Each housing 815, 825 may include extensions that are angled acutely in relations to an axis of the primary module's length. Each housing 810, 820 also extends a corresponding distance D2 and D3 away from a respective end of primary module 510. The game modules 810, 820 are attached so the distances D2 and D3 are completely additive to L.

F. Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A handheld computer assembly comprising:
a first module including a first housing having a front surface and a back surface, a first surface extending between the front surface and the back surface, and a second coupling surface extending between the front surface and the back surface, a distance between the first surface and the second coupling surface defining a length of the first module, the first module including a first coupling mechanism that extends from the second coupling surface; and
a second module coupleable to the first module, the second module including a second housing having a third coupling surface, and a second coupling mechanism that extends from the third coupling surface to mate with the first coupling mechanism, the third coupling surface being positioned on the second module so as to abut at least partially against the second coupling surface when the first coupling mechanism is mated with the second coupling mechanism.

2. The handheld computer assembly of claim 1, wherein a width of the third coupling surface is within 75% of a width of the second coupling surface.

3. The handheld computer assembly of claim 2, wherein the width of the third coupling surface is approximately the same as the width of the second coupling surface.

4. The handheld computer assembly of claim 2, wherein a depth of the third coupling surface is within 75% of a depth of the second coupling surface.

5. The handheld computer assembly of claim 4, wherein the depth of the third coupling surface is approximately the same as the depth of the second coupling surface.

6. The handheld computer assembly of claim 1, wherein the first module includes a display and a processor.

7. The handheld computer assembly of claim 6, wherein the second module is selectable from a group of modules consisting of a power source, a storage unit, a processor component, a transmitter, and a combination thereof.

8. The handheld computer assembly of claim 1, wherein the first coupling mechanism and the second coupling mechanism each include a pin connector.

9. The handheld computer assembly of claim 1, wherein the first coupling mechanism and the second coupling mechanism each include a mechanical coupling.

10. The handheld computer assembly of claim 9, wherein the first coupling mechanism and the second coupling mechanism each include an electrical coupling spaced apart from the mechanical coupling.

11. The handheld computer assembly of claim 1, wherein the first module includes a processor, and the second module includes at least one component selected from a group of components consisting of a power pack, a memory, an analog-to-digital converter, an input mechanism, an antenna, and a second processor.

12. The handheld computer assembly of claim 11, wherein the first module includes a display.

13. The handheld computer assembly of claim 12, wherein the display is contact-sensitive.

14. The handheld computer assembly of claim 1, wherein a length or width of the second housing extends between the third coupling surface and a fourth surface opposing the third coupling surface.

15. The handheld computer assembly of claim 1, wherein the second housing is shaped so that so that all of a length or width of the second housing is additive to the length of the first housing when the second module is coupled to the first module.

16. The handheld computer assembly of claim 15, wherein the second module is dimensioned so that at least a portion of the front surface of the second housing is coplanar with at least a portion of the front surface of the first housing when the second module is coupled to the first module.

17. The handheld computer assembly of claim 1, wherein the first module includes a contact-sensitive display, and wherein the second module includes an input mechanism positioned on a front surface of the second housing, the front surface of the second housing and the front surface of the first housing both being oriented in a first direction.

18. The handheld computer assembly of claim 17, wherein the front surface of the second housing includes a plurality of buttons.

19. A handheld computer assembly comprising:
a first module including a first coupling on a first coupling surface and a second coupling on a second coupling surface, the first module including a front panel and a back panel extending a length of the first module, the first coupling surface and the second coupling surface each extending between the front panel and the back panel;
a second module including a third coupling on a third coupling surface, the third coupling being coupleable to one of the first coupling or the second coupling so that the third coupling surface abuts a corresponding one of the first coupling surface or the second coupling surface; and
a third module including a fourth coupling on a fourth coupling surface, the fourth coupling being coupleable to another of the first coupling or the second coupling to that the fourth coupling surface abuts another corresponding one of the first coupling surface or the second coupling surface.

20. The handheld computer assembly of claim 19, wherein the first module, the second module and the third module each include least one component selected from a group of components consisting of a power pack, a memory, an analog-to-digital converter, an input mechanism, an antenna, and a second processor.

21. The handheld computer assembly of claim 19, wherein at least two of the first coupling, second coupling, third coupling and fourth coupling include pin connectors.

22. The handheld computer assembly of claim 19, wherein at least two of the first coupling, second coupling, third coupling and fourth coupling include a mechanical coupling spaced apart from an electrical coupling.

23. The handheld computer assembly of claim 19, wherein a length of the first module extends between the first coupling surface and the second coupling surface.

24. The handheld computer assembly of claim 19, wherein at least an entire peripheral edge of the first coupling surface is in contact with the peripheral edge of the third coupling surface when the first coupling mechanism is combined with the second coupling mechanism.

25. A handheld computer module comprising:
a housing having a front surface extending a first length between a first coupling surface and a second coupling surface, a back surface opposing the front surface;
a first coupling mechanism extending from the first coupling surface, the first coupling mechanism being configured to attach to another coupling mechanism of a second module, the first coupling mechanism being positioned so that a dimension of the second module is additive to the first length when the first coupling mechanism is attached to the second module; and
a second coupling mechanism extending from the second coupling surface, the second coupling mechanism being configured to attach to another coupling mechanism of a third module, the third coupling mechanism being positioned so that a dimension of the third module is additive to the first length when the second coupling mechanism is attached to the third module.

26. The handheld computer module of claim 25, wherein the first coupling surface is substantially parallel to the second coupling surface.

27. The handheld computer module of claim 25, wherein the first coupling mechanism is positioned so that all of the second module's dimension is additive to the first length,

28. The handheld computer module of claim 27, wherein the second coupling mechanism is positioned so that all of the third module's dimension is additive to the first length.

29. The handheld computer module of claim 25, further comprising a contact-sensitive display.

30. The handheld computer module of claim 25, wherein at least one of the first coupling mechanism and the second coupling mechanism includes a pin connector.

31. The handheld computer module of claim 25, at least one of the first coupling mechanism and the second coupling mechanism includes a mechanical coupling spaced apart from an electrical coupling.
